(19) United States
(12) Patent Application Publication
(10) Pub. No.: US 2019/0347833 A1
(43) Pub. Date: Nov. 14, 2019

(54) HEAD-MOUNTED ELECTRONIC DEVICE AND METHOD OF UTILIZING THE SAME

(71) Applicant: Young Optics Inc., Hsinchu (TW)

(72) Inventors: Chih-Shan Tsai, Hsinchu (TW); Ching-Chao Tsai, Hsinchu (TW)

(73) Assignee: Young Optics Inc., Hsinchu (TW)

(21) Appl. No.: 16/402,221

(22) Filed: May 2, 2019

(30) Foreign Application Priority Data
May 8, 2018 (TW) 107115580

(51) Int. Cl. G06T 11/00; H04N 9/31; G06F 3/01

(52) U.S. Cl. CPC G06T 11/001; H04N 9/3197; H04N 5/45; G06F 3/017; G06T 2200/24; H04N 9/3182

(57) ABSTRACT

A head-mounted electronic device including a head-mounted frame, a lens, a photosensitive element, a projector, an optical element, a processor, and a memory is provided. The lens and the projector are disposed on the head-mounted frame. The photosensitive element is adapted to obtain first image data of a first target and body image data of a second target. The processor is electrically coupled to the photosensitive element and the projector. The memory storing color data, a first program, and a feature enhancement program, wherein the first program generates third image data according to the first image data and the color data for the projector to generate a third image on a reflective surface of the optical element. The feature enhancement program according to the body image data and the third image data for the projector to generate a fourth image on the reflective surface.

### CROSS-REFERENCE TO RELATED APPLICATION

This application claims the priority benefit of Taiwan application serial no. 107115580, filed on May 8, 2018. The entirety of the above-mentioned patent application is hereby incorporated by reference herein and made a part of this specification.

### BACKGROUND OF THE INVENTION

### Technical Field

This disclosure generally relates to an electronic device and a method of utilizing the same. More particularly, to a head-mounted electronic device and a method of utilizing the same.

### Description of Related Art

Color blindness or color vision deficiency is an inability to distinguish certain colors, which often results from an inheritance, age, or disease. The color identification inability is mainly caused by damages to optic nerves or brains or congenital gene disorders, and therefore some assisting devices for people suffering from color blindness or color vision deficiency may be applied.

With the advancement of science and technology, types and functions of electronic devices and the way to utilize the electronic devices have become more and more diverse. The head-mounted display devices, which can be directly worn by users, have been developed accordingly. There are many types of head-mounted display devices. For instance, if a user wears an eyeglass-type of the head-mounted display device, the user is able to see enlarged virtual images or stereoscopic images; what is more, the images may be changed while the user's head turns, which helps create a more immersive experience. Hence, how to further utilize high-tech products as an assisting devices for people suffering from color blindness or color vision deficiency is one of the topics which researchers and developers in the pertinent field are dedicated to explore.

### SUMMARY

The disclosure provides a head-mounted electronic device and a method of utilizing the same, so as to help users suffering from color blindness or color vision deficiency enhance their accurate perception of environment or everyday life.

In an embodiment of the disclosure, a head-mounted electronic device including a camera, an image source, an optical element, a memory, and a controller is provided. The camera is adapted to obtain first image data of a first target and second image data of a second target. The optical element has a reflective surface and is disposed on an optical path of the image source. The memory stores first data, a first program, and a feature enhancement program. The first program generates third image data according to the first image data and the first data for the projector to generate a third image on the reflective surface of the optical element. The feature enhancement program enables the projector to generate a fourth image on the reflective surface according to the body image data and the third image data. The controller is configured to run the first program and the second program.

In another embodiment of the disclosure, a head-mounted electronic device including a head-mounted frame, a lens, a photosensitive element, a projector, an optical element, a processor, and a memory is provided. The lens and the projector are disposed on the head-mounted frame. The photosensitive element is disposed on an optical path of the lens and adapted to obtain first image data of a first target and body image data of a second target. The optical element is disposed on an optical path of the projector. The processor is electrically coupled to the photosensitive element and the projector. The memory stores color identification capability data, a first program, and a feature enhancement program. The first program generates third image data according to the first image data and the color identification capability data for the projector to generate a third image on a reflective surface of the optical element. The feature enhancement program enables the projector to generate a fourth image on the reflective surface according to the body image data and the third image data.

In another embodiment of the disclosure, a method of utilizing a head-mounted electronic device includes: providing the aforesaid head-mounted electronic device; obtaining first image data of a first target; generating a third image in a window mode according to the first image data and color identification capability data; generating a fourth image according to body image data and third image data.

In view of the above, according to the head-mounted electronic device and the method of utilizing the same as provided in one or more embodiments of the disclosure, the head-mounted electronic device is adapted to obtain the first image data of the first target and accordingly provide the third image whose color is corrected, and the head-mounted electronic device allows the user to further provide the body image data of the second target according to actual needs and adjust or correct the third image, so as to generate the fourth image matching the first target. As such, the user may enhance the accurate perception of the environment or everyday life.

To make the above features and advantages provided in one or more of the embodiments of the disclosure more comprehensible, several embodiments accompanied with drawings are described in detail as follows.

### BRIEF DESCRIPTION OF THE DRAWINGS

The accompanying drawings are included to provide a further understanding of the disclosure and are incorporated in and constitute a part of this specification. The drawings illustrate embodiments of the disclosure and, together with the description, serve to explain the principles described herein.

FIG. 1 is a schematic view briefly illustrating a head-mounted electronic device according to an embodiment of the disclosure.

FIG. 2 is another schematic view briefly illustrating the head-mounted electronic device depicted in FIG. 1.

FIG. 3A to FIG. 3C are schematic views illustrating a process of utilizing a head-mounted electronic device according to an embodiment of the disclosure.

FIG. 4A to FIG. 4C are schematic views illustrating a process of utilizing a head-mounted electronic device according to another embodiment of the disclosure.

FIG. 5A and FIG. 5B are schematic views illustrating a process of utilizing a head-mounted electronic device according to an embodiment of the disclosure.

FIG. 6 is a flowchart of utilizing a head-mounted electronic device according to an embodiment of the disclosure.

### DETAILED DESCRIPTION OF EMBODIMENTS

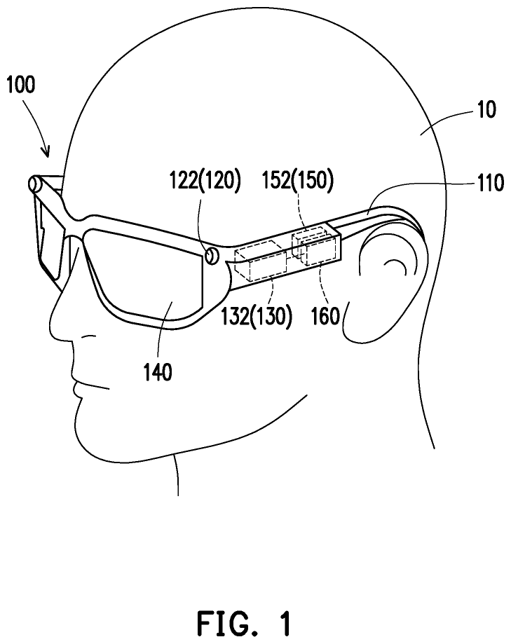

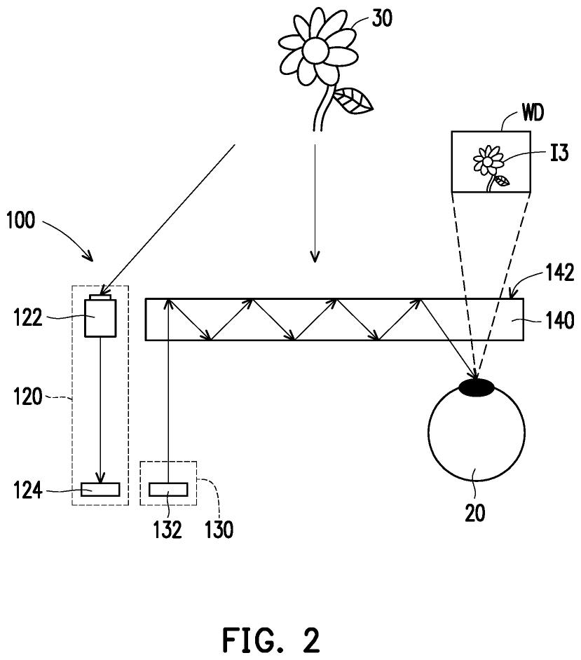

FIG. 1 is a schematic view briefly illustrating a head-mounted electronic device according to an embodiment of the disclosure. FIG. 2 is another schematic view briefly illustrating the head-mounted electronic device depicted in FIG. 1.

The head-mounted electronic device is described in the embodiment provided below. With reference to FIG. 1 and FIG. 2, the head-mounted electronic device 100 provided in an embodiment of the disclosure includes a camera 120, an image source 130, an optical element 140, a controller 150, and a memory 160.

The head-mounted electronic device 100 is, for instance, a near-eye display (NED) or a head-mounted display (HMD), and the display technology be an augmented reality (AR) technology or a virtual reality (VR) technology, which should not be construed as limitations in the disclosure. In the present embodiment, a user 10 suffering from color blindness or color vision deficiency or having difficulty in identifying colors may improve his or her visual perception through wearing the head-mounted electronic device 100, thereby improving the Accurate perception of environment or everyday life. Here, the head-mounted electronic device 100 utilizes the AR technology.

The head-mounted frame 110 is, for example, a spectacle frame or a frame similar in appearance to eyeglasses and is configured to be placed around the eyes of the user 10, and the head-mounted frame 110 may be supported by facial features of the user 10, for example, by the nose or the ears of the user 10. In another embodiment, the head-mounted frame 110 may also be an ear-hook type frame and is placed on one eye of the user 10.

The camera 120 is configured to convert the captured image data into electric signal data, and the camera 120 is, for instance, an optical device capable of capturing images. In the present embodiment, the field of view of the camera 120 is greater than or equal to 90 degrees. The camera 120 provided in the present embodiment at least includes a lens 122 and a photosensitive element 124. Specifically, the lens 122 includes one optical lens or a combination of optical lenses having diopters, e.g., a combination of non-planar lenses, such as a biconcave lens, a biconvex lens, a concave-convex lens, a convex-concave lens, a plano-convex lens, and a plano-concave lens. In an embodiment, the lens 122 includes 4 to 10 lenses having diopters.

The photosensitive element 124 is a charge coupled device (CCD), a complementary metal oxide semiconductor transistor (CMOS), or the like, for instance. In the present embodiment, the photosensitive element 124 is a CCD.

The image source 130 is configured to provide a light beam to a target on a transmission path of the light beam; in the present embodiment, the image source 130 is a projector 132, a display screen, or another imaging device, for instance.

The projector 132 may output an image beam, so as to project the image to the optical device of the target. The projector 132 has a light source, a light valve, and a projection lens. The light source provides a light beam to the light valve to generate an image beam, and the image beam is transmitted to the projection lens and then projected onto the target. The light source may be any type of diode light emitting devices, and the light valve may be a liquid crystal display (LCD) panel, a liquid crystal on silicon (LCOS) panel, or a digital micromirror device (DMD).

The projection lens may include a plurality of lenses having diopters. In the present embodiment, the projector 132 utilizes an LED light source and is equipped with the DMD and the projection lens constituted by six lenses. If necessary, a reflective mirror may be disposed at the light exit of the projector 132, so as to change the direction in which a light beam enters the projector 132. In the present embodiment, the field of view of the projector 132 may be optically greater than or equal to 90 degrees.

The optical element 140 may be a waveguide plate or a planar lens or a non-planar lens having diopters. For instance, the optical element 140 may be the non-planar lens including a biconcave lens, a biconvex lens, a concave-convex lens, a convex-concave lens, a plano-convex lens, and a plano-concave lens or any other element that may be applied to transmit the image beam, such as a prism or an integral rod. In the present embodiment, the optical element 140 is a waveguide plate having a plurality of waveguide gratings/holograms in different colors.

The controller 150 is configured to run software and programs to edit built-in data or the electric signal data captured and converted by the camera 120. In the present embodiment, the controller 150 includes a processor 152. The processor 152 is, for instance, a central processing unit (CPU), a programmable general-purpose or special-purpose microprocessor, a digital signal processor (DSP), a programmable controller, an application specific integrated circuit (ASIC), any other similar element, a combination of said elements, or peripherals required for data processing.

The memory 160 is any type of fixed or movable random access memory (RAM), read-only memory (ROM), flash memory, any other similar element, or a combination of said elements. In the present embodiment, the memory 160 is a flash memory that can store data or image data.

With reference to FIG. 1 and FIG. 2, in the present embodiment, the camera 120 is placed on the head-mounted frame 110, and the photosensitive element 124 in the camera 120 is disposed on an optical path of the lens 122. To be specific, the lens 122 and the photosensitive element 124 are disposed on the same side of the head-mounted frame 110, so as to use the same optical path.

When the head-mounted electronic device 100 is being used, the camera 120 may capture light from surroundings 30 (or be referred to as a first target) and generate corresponding first image data.

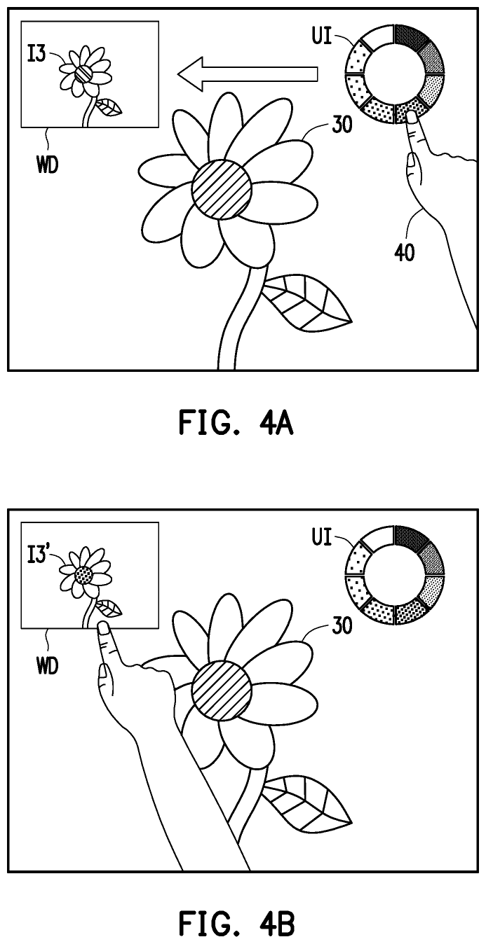

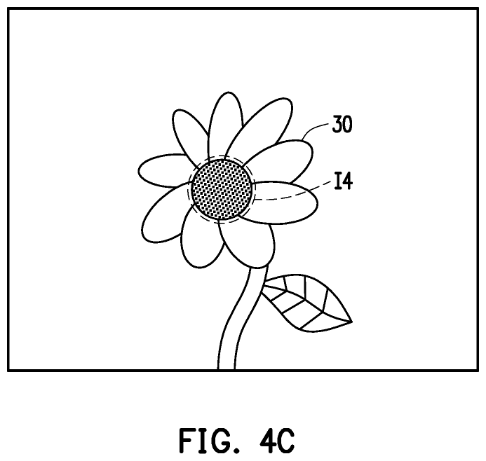

While the light coming from the surroundings is being captured, the camera 120 may simultaneously capture light coming from specific body parts 40 (or a second target 40 shown in FIG. 4A) and generate corresponding body image data (also referred to as second image data).

According to the present embodiment, the first target 30 is a physical object in the environment, such as a building, plant, a traffic sign, or any other target in the environment or everyday life. The second target 40 may be an indicator object that may be spatially operated and may vary, a gesture of the user 10, or any other body motion that may result in the image change.

In another aspect, the projector 132 is disposed on the head-mounted frame 110, and the optical element 140 is disposed on the optical path of the projector 132. To be specific, the projector 132 is disposed on the same side of the head-mounted frame 110, so as to use the optical path. When head-mounted electronic device 100 is being used, the projector 132 may provide an image frame and transmit and converge it onto the reflective surfaces 142 of the optical element 140. Hence, the image frame is reflected by the reflective surfaces 142 to eyes 20 of the user 10. As such, the user 10 wearing the head-mounted electronic device 100 is able to observe ambient images and the image frame projected by the projector 132.

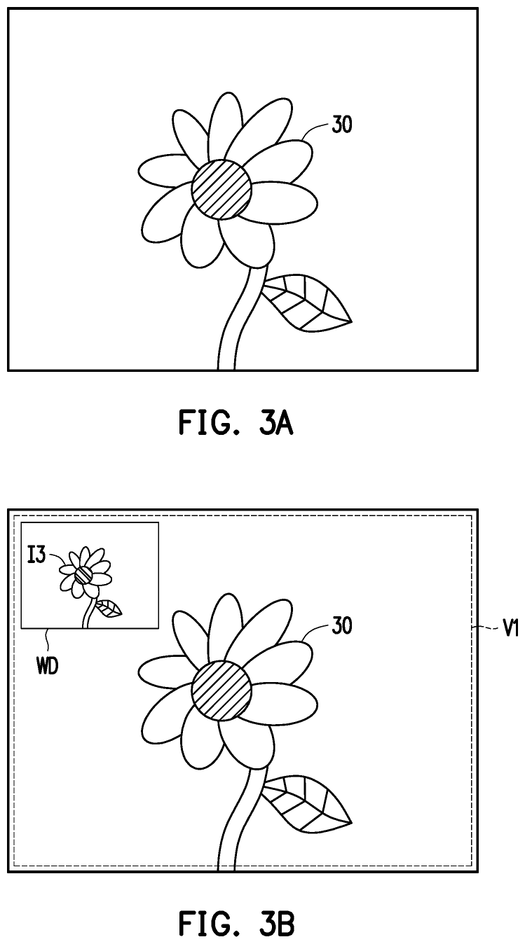

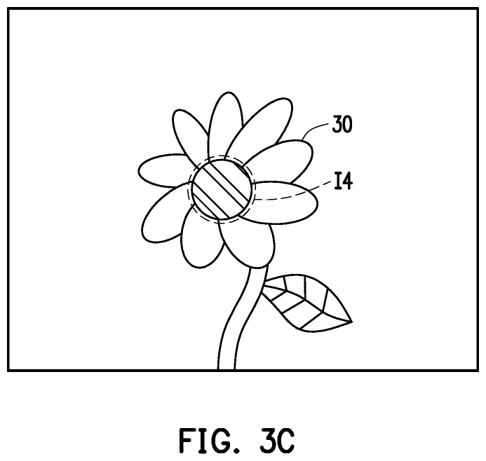

FIG. 3A to FIG. 3C are schematic views illustrating a process of utilizing a head-mounted electronic device according to an embodiment of the disclosure. With reference to FIG. 1 to FIG. 3C, in the present embodiment, the processor 152 and the photosensitive element 124 are electrically coupled to the projector 132. The memory 160 stores color identification capability data, a color correction program (a first program), and a feature enhancement program (a second program).

In the present embodiment, the color identification capability data (also referred to as color data or first data) may include, for example, built-in preset data of different colors, data indicating the ability of the user 10 to identify different colors, color correction module data for the user 10, or a combination thereof.

On the other hand, the color correction program (the first program) may be run by the processor 152. When the head-mounted electronic device 100 is being used, the memory 160 may store ambient image data (first image data) generated by the camera 120 and corresponding to the ambient image, for example, and the color correction program may, based on the color identification capability data stored in the memory 160, calculate and adjust the ambient image data (generated by the camera 120) according to the user's color identification capability as well as generate the image whose color is already corrected. The image which has undergone the color correction is obtained by processing the ambient image, and therefore the image which has undergone the color correction and the ambient image at least partially correspond to each other. Here, the image which has undergone the color correction may be referred to as a third image, and the corresponding image data may be referred to as third image data.

After color correction is completed, the processor 152 may transmit the third image data to the projector 132 to project the third image 13 which has undergone the color correction, and the third image 13 may be reflected by a plurality of reflective surfaces 142 of the optical element 140 and may then be output to the eyes of the user. Thereby, the user 10 is able to observe the third image 13 in the form of a virtual image through the reflective surfaces 142. Since the third image 13 is a virtual image, in comparison with the real image, the distance between the eyes and the optical element 140 may be shorter, and the system volume may, therefore, be reduced.

According to the present embodiment, at the user's view angle, the user not only can see the image of the surroundings as shown in FIG. 3A through the optical element 140 but also can see the third image 13 presented in a window mode WD as shown in FIG. 3B through the optical element 140. That is, the color of the physical object itself is not adjusted, but the color of the image in the window mode WD has been adjusted according to the user's color identification capability. Thereby, the user is able to learn the difference between the color he or she sees and the actual color of the object and make progress accordingly.

According to some embodiments, in the window mode WD, multiple images may be displayed according to actual needs, so as to facilitate the comparison of images in depth. The third image 13 in some embodiments may also be displayed in a transparent or near-transparent manner. In the present embodiment, the image source is, for instance, the projector 132, and it is assumed that the maximum coverage of the projector 132 which can be observed by the user is 100%. In this case, when the window accounts for 80%, 60%, or 30% or less in the third image 13, the visual effects are good, better, and the best. As shown in FIG. 3B, the third image 13 accounts for approximately 10%, for instance.

On the other hand, the processor 152 is able to run a feature enhancement program (also referred to as the second program). The feature enhancement program may calculate, based on the color identification capability data stored in the memory 160, the first image data or the third image data according to the user's ability to identify colors, and then perform operation and adjustment to generate an image which has undergone a color correction. A color block (the fourth image 14) is then displayed in a corresponding region matching the first target 30 in the field of view, as shown in FIG. 3C.

Thereby, the user 10 not only can observe the third image 13 undergoing the color correction through the window to identify the corrected color of the first target 30 but also can further correct or enhance the color performance of the first target 30, so as to improving the accurate perception of the first target 30.

FIG. 4A to FIG. 4C are schematic views illustrating a process of utilizing a head-mounted electronic device according to another embodiment of the disclosure. With reference to FIG. 2 and FIG. 4A to FIG. 4C, in the present embodiment, the user 10 may further correct the desired correction color through gestures. Specifically, in the steps shown in FIG. 3B above, the feature enhancement program may further evaluate the user's command based on, for example, the body image data relative to the user's body, so that the color of the specific region in the third image data may be replaced or adjusted according to the user's command, and the image data may be output as the third image 13′ with the corrected color. The third image 13′ corresponds to the third image data or the fourth image. In other words, the corrected third image data or the fourth image is generated according to the corrected third image. The user 10 may, according to the environmental or other needs, adjust the third image 13 which has undergone the color correction.

In brief, according to the present embodiment, the first image data corresponding to the image data is obtained by capturing the images of the surroundings by the camera 120. The second image data corresponding to the image data is obtained by capturing the body images by the camera 120. The third image data corresponding to the image data is obtained after the first image data are adjusted according to the color identification capability data (the first data). The fourth image data corresponding to the image data is obtained after the first image data or the third image data are adjusted according to the second image data.

In particular, the feature enhancement program may correct the third image data according to the body image data, and the third image 13 is changed according to the correction of the third image data. The feature enhancement program may display a user interface UI, which may be a color palette, a color code table, or may be expressed in texts, for instance. The following description will be made while the user interface UI is the color palette. Specifically, during the adjustment, the user 10 may operate the user interface UI through sliding gestures, clicking actions, or other actions, so that the photosensitive element 124 obtains the body image data and correct the same to the third image data. The user 10 may then correct the third image 13 to the corrected third image 13′ through operating the user interface UI, as shown in FIG. 4B. The corrected parts are, for instance, changes to colors or patterns of certain regions in the third image 13 or addition of feature drawings.

After the third image 13 is corrected, the corrected third image 13′ may be displayed in the window mode WD instantaneously; optionally, after the user's further confirmation, the third image 13′ in the window mode WD may be projected to match the first target 30 in the field of view. The user 10 is then allowed to observe the fourth image 14 which has undergone the user's correction through the optical element 140, as shown in FIG. 4C. Thereby, the user is able to further determine the color or determine the way to correct the color, which enhances the color performance of the third image 13 and further improve the accurate perception of the first target 30. Besides, in addition to the display of the user interface UI through projection, it is also likely to adhere patterns to one part of the reflective surfaces 142.

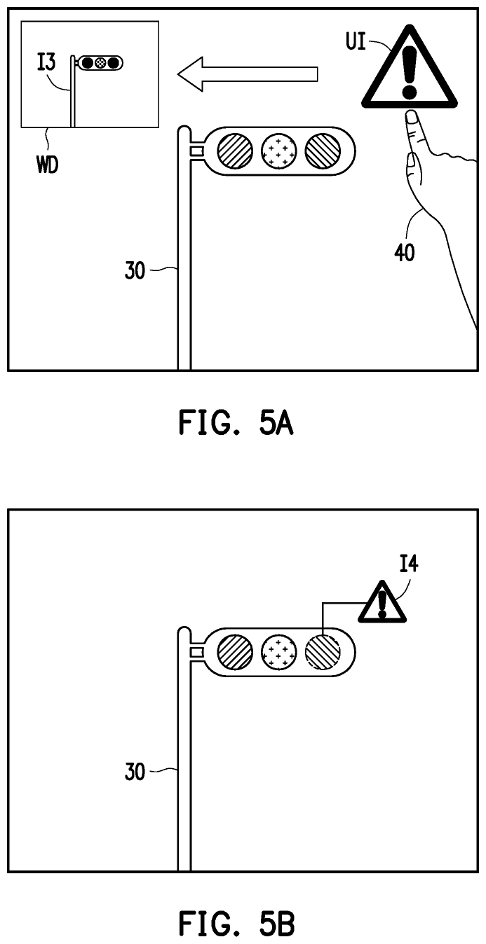

FIG. 5A and FIG. 5B are schematic views illustrating a process of utilizing a head-mounted electronic device according to an embodiment of the disclosure. With reference to FIG. 2, FIG. 5A, and FIG. 5B, in the present embodiment, the user 10 may further enhance some regions of the first target 30 with the use of the feature enhancement data. Particularly, in the present embodiment, the memory 160 further stores feature data, and the feature enhancement program may add the feature data to the third image data according to the body image data, so that a displayed image frame of the fourth image 14 may include at least one feature drawing, e.g., a warning drawing. During the adjustment provided in the present embodiment, the user 10 may further select the desired feature drawing and add the same to the third image 13 through operating the user interface UI, as shown in FIG. 5A. After the user's further confirmation, the third image in the window mode WD may be projected onto the reflective surfaces 142 to match the first target 30 in the field of view. The user 10 is then allowed to observe the fourth image 14 which has undergone the user's correction through the optical element 140, as shown in FIG. 5B. As a result, the user 10 may further improve the perception of the first target 30 through enhancing other display effects in specific regions.

In any of the previous embodiments, the color identification capability data stored in the memory 160 may be updated after the feature enhancement program corrects the third image data. Namely, if the user 10 further improves the display frames through running the feature enhancement program, the memory 160 may correct and update the color identification capability data based on the editing action of the user 10. As such, deep learning may be achieved through smart computation, which further facilitates the user's operations. Besides, the information of the user's operations may be further provided to an additional computer system or to the network cloud, so as to further generate an available color correction mode.

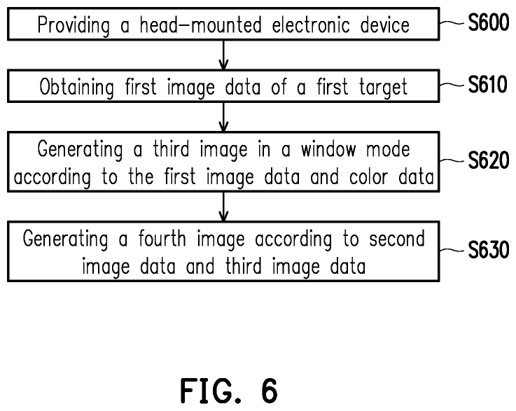

FIG. 6 is a flowchart of utilizing a head-mounted electronic device according to an embodiment of the disclosure. With reference to FIG. 1, FIG. 2, and FIG. 6, in the present embodiment, step S600 is performed to provide the head-mounted electronic device 100 provided in any of the previous embodiments. Step S610 is then performed to obtain the first image data of the first target 30. After the first image data are obtained, step S620 is performed to generate the third image 13 in the window mode according to the first image data. Step S630 is then performed to generate the fourth image (e.g., the fourth image 14 shown in FIG. 3C) according to the second image data (the body image data) and the third image data.

Specifically, in the present embodiment, the step S630 in which the fourth image is generated according to the second image data (the body image data) and the third image data may further include a step of correcting the third image data through operating a user interface according to the second image data (the body image data) and a step of generating the fourth image according to the corrected third image data. Alternatively, the step S630 may include a step of updating the color data (the color identification capability data) according to the corrected third image data. Further, in the present embodiment, the memory 160 may include feature data, and the step of correcting the third image data through operating the user interface according to the second image data (the body image data) may further include a step of adding the feature data to the third image data according to the second image data (the body image data), so that a displayed image frame of the third image may include at least one feature drawing.

On the other hand, the head-mounted electronic device 100 provided in one or more of the previous embodiments utilizes the AR technology, while the AR technology may be replaced by the VR technology in another embodiment. If the VR technology is applied, the optical element 140 in front of the eyes of the user need not be transparent. In an embodiment, an image source and a lens assembly are placed in front of each eye of the user, and each image source is an LCD screen, for instance. Besides, images of the objects saw by the user are all taken by a camera and are then displayed on a display. Since the operational manner in which the VR technology is applied is similar to the operational manner in which the AR technology is applied, no further explanation is provided hereinafter.

To sum up, according to the head-mounted electronic device and the method of utilizing the same as provided in one or more embodiments of the disclosure, the head-mounted electronic device is adapted to obtain the first image data of the first target and accordingly provide the third image whose color is corrected, and the head-mounted electronic device allows the user to further provide the body image data of the second target according to actual needs and correct or adjust the third image, so as to generate the fourth image matching the first target. As such, the user may enhance the accurate perception of the environment or everyday life.

It will be apparent to those skilled in the art that various modifications and variations can be made to the structure described in the disclosure without departing from the scope or spirit of the disclosure. In view of the foregoing, it is intended that the disclosure cover modifications and variations provided they fall within the scope of the following claims and their equivalents.

What is claimed is:

1. A head-mounted electronic device comprising:
a head-mounted frame;
a lens disposed on the head-mounted frame;
a photosensitive element disposed on an optical path of the lens and adapted to obtain first image data of a first target and body image data of a second target;
a projector disposed on the head-mounted frame;
an optical element having a reflective surface and disposed on an optical path of the projector;
a processor electrically coupled to the photosensitive element and the projector; and
a memory storing color data, a first program, and a second program, wherein the first program generates third image data according to the first image data and the color data for the projector to generate a third image on the reflective surface of the optical element, and the second program enables the projector to generate a four image on the reflective surface of the optical element according to the body image data and the third image data.

2. The head-mounted electronic device of claim 1, wherein a field of view of the head-mounted electronic device is greater than or equal to 90 degrees.

3. The head-mounted electronic device of claim 1, wherein the third image is displayed on a window.

4. The head-mounted electronic device of claim 1, wherein the second program corrects the third image data according to the second image data, the third image data are changed according to the correction of the third image data, and the second program is adapted to display a user's interface.

5. The head-mounted electronic device of claim 1, wherein the memory further stores feature data, and the second program adds the feature data to the third image data according to the second image data, so that a displayed image frame of the fourth image comprises at least one feature drawing.

6. The head-mounted electronic device of claim 5, wherein the at least one feature drawing is a warning drawing or other functional drawing.

7. The head-mounted electronic device of claim 1, wherein a second target is an indicator object that spatially operated and vary, a gesture of a user, or any other body motion that may result in the image change.

8. A head-mounted electronic device comprising:
a camera adapted to obtain first image data of a first target and second image data of a second target;
an image source;
an optical element having a reflective surface and disposed on an optical path of the image source;
a memory storing first data, a first program, and a second program, wherein the first program generates third image data according to the first image data and the first data for the image source to generate a third image on the reflective surface of the optical element, and the second program enables the image source to generate a four image on the reflective surface of the optical element according to the second image data and the third image data; and
a controller configured to run the first program and the second program.

9. The head-mounted electronic device of claim 8, wherein a field of view of the head-mounted electronic device is greater than or equal to 90 degrees.

10. The head-mounted electronic device of claim 8, wherein the third image is displayed on a window.

11. The head-mounted electronic device of claim 8, wherein the second program corrects the third image data according to the second image data, the third image data are changed according to the correction of the third image data, and the second program is adapted to display a user's interface.

12. The head-mounted electronic device of claim 8, wherein the memory further stores feature data, and the second program adds the feature data to the third image data according to the second image data, so that a displayed image frame of the fourth image comprises at least one feature drawing.

13. The head-mounted electronic device of claim 12, wherein the at least one feature drawing is a warning drawing or other functional drawing.

14. The head-mounted electronic device of claim 8, wherein a second target is an indicator object that spatially operated and vary, a gesture of a user, or any other body motion that may result in the image change.

15. A method of utilizing a head-mounted electronic device, the method comprising:
obtaining first image data of a first target;
obtaining second image data of a second target;
displaying the third image in a window according to the first image data and color data, and
generating a fourth image according to second image data and third image data.

16. The method of claim 15, wherein the step of generating the fourth image according to the second image data and the third image data comprises:
correcting the third image data through operating a user's interface according to the second image data, and
generating the fourth image according to the corrected third image data.

17. The method of claim 16, wherein the step of correcting the third image data through operating the user's interface according to the second image data comprises:
adding feature data to the third image data according to the second image data, so that a displayed image frame of the third image comprises at least one feature drawing.

18. The method of claim 17, wherein the at least one feature drawing is a warning drawing or other functional drawing.

19. The method of claim 16, further comprising:
updating the color data according to the third image data after correcting the third image data.

20. The method of claim 15, wherein the second target is an indicator object that spatially operated and varies, a gesture of a user, or any other body motion that may result in the image change.
